(19) United States
(12) Patent Application Publication
(10) Pub. No.: US 2015/0368508 A1
(43) Pub. Date: Dec. 24, 2015

(54) COATING COMPOSITIONS AND ARTICLES MADE THEREFROM

(71) Applicant: 3M INNOVATIVE PROPERTIES COMPANY, Saint Paul, MN (US)

(72) Inventors: Rajan B. Bodkhe, Woodbury, MN (US); Leon Levitt, Mendota Heights, MN (US); Craig M. Moss, Woodbury, MN (US)

(21) Appl. No.: 14/764,711

(22) PCT Filed: Jan. 31, 2014
(86) PCT No.: PCT/US2014/014023

§ 371 Date: Jul. 30, 2015

Related U.S. Application Data
(60) Provisional application No. 61/792,077, filed on Mar. 15, 2013.
(60) Provisional application No. 61/759,468, filed on Feb. 1, 2013.

(51) Int. Cl. C09D 171/02; B05D 3/00

(52) U.S. Cl. CPC C09D 171/02; B05D 3/007

(57) ABSTRACT

There is provided a one-part, moisture curable coating composition comprising: a silyl terminated polymer, wherein the silyl terminated polymer is polyoxyalkylene polymer having at least one end group derived from an alkoxy silane, and a polyether plasticizer, and further the polyether plasticizer has a number average molecular weight between 300 g/mol to 600 g/mol. There are also provided articles and films made using and methods for using these coating compositions.

### FIELD

The present disclosure relates to coating compositions. The present disclosure also relates to articles and films made using the coating compositions. The present disclosure further relates to a method for allowing water vapor transport and blocking air and liquid water across a surface of a structure using the coating compositions.

### BACKGROUND

Air barrier systems control movement of air, and specifically water vapor, across a surface of a structure, such as a building enclosure. In exterior walls, uncontrolled air flow is the greatest source of moisture and condensation damage. Indoor comfort is affected by air temperature, relative humidity, direction of airflow and surrounding surface temperatures. Indoor air quality is enhanced by air barrier systems by keeping pollutants out of building interiors and is an efficient way of keeping pollutants out. Pollutants include water vapor, suspended particulates, dust, insects, smells, etc. Air barrier systems have significant impact on electricity consumption and gas bills. Air barrier systems in nonresidential buildings are estimated to reduce air leakage by up to 83 percent, saving on gas bill more than 40% and reducing electricity consumption more than 25% according to simulations by the National Institute of Standards and Technology (NIST) of typical buildings without air barriers. Water vapor is a key ingredient in corrosion and mold growth. Air barrier systems help prevent water vapor from being transported by air movement between exteriors and interiors of structures, such as buildings.

Use of air barrier systems has been a requirement in Canada for almost 25 years and is becoming important in North America due to net zero energy requirements by 2030, required by the US Army Corp of Engineering, ASHRAE 90, and International Energy Conservation Code—2009. On Dec. 16, 2011, the DC Construction Codes Coordinating Board (CCCB) adopted the 2012 International Energy Conservation Code (IECC). The code now is under administrative review and legislative process, with adoption likely in the second half of 2013.

Previously known waterproofing sheets having both waterproofing property and moisture permeability have been developed. One typical example of such moisture-permeable waterproofing sheets is flash-spun nonwoven fabrics. U.S. Pat. No. 3,169,899, for example, discloses a flash-spun nonwoven fabric. U.S. Pat. No. 3,532,589 discloses a method for producing a flash-spun nonwoven fabric. The nonwoven fabric thus obtained has an appropriate pore size. It blocks water, but allows air and water vapor to pass therethrough. A known example of the nonwoven fabric is commercially available under the trade designation “Tyvek” from E. I. Du Pont de Nemours and Company, Wilmington, Del. USA obtained by thermo-compressing a three-dimensionally-meshed fiber of high-density polyethylene. Such a moisture-permeable waterproofing sheet can prevent external water from infiltrating through the sheet, but can drain gathered moisture as water vapor.

However, the openings such as windows or doors are not flat. It is difficult to form a waterproofing layer only with a waterproofing sheet, and therefore the opening is often finished with a waterproofing tape with a pressure sensitive adhesive layer provided thereon. In this case, since the pressure sensitive adhesive layer is made of rubber or asphalt materials, the moisture permeability of the entire tape decreases, and the same problem as that of a common waterproofing sheet can occur.

Mechanical fasteners or adhesive fasteners, such as pressure sensitive adhesive tapes, can be used to affix the moisture-permeable waterproofing sheet on substrates of exterior walls or to affix overlapped portions of two moisture-permeable waterproofing sheets. As a result, moisture may permeate from gaps of such fasteners, such as nail holes or pressure sensitive adhesive tapes, over a long period of time.

However, a composition used in a liquid-applied waterproofing material disclosed in U.S. Pat. Publ. No. 2007/0042196 A1, etc. contains a latex polymer (aqueous emulsion). Such a composition requires a long period of time to form a continuous layer if it is coated in a condition at a low temperature, or a high humidity. Thus, it is difficult to apply the composition in inclement weather conditions. Moreover, since the coating of the latex polymer is poor in elasticity, it is not able to resist a prolonged strain of a substrate. Thus, cracks, breaks, etc. may occur in or on the coating, and waterproofing property may be deteriorated.

On the other hand, it has been known that an organic polymer that contains at least one reactive silicon group in a molecule can give a rubbery cured product. Such an organic polymer can crosslink even at a room temperature by forming siloxane bond through hydrolysis of the reactive silicon group under an existence of moisture in the air. For example, WO 2011/046235 A1 discloses silyl terminated polymers. In order to achieve acceptable permeability, functional polyether plasticizers, such as hydroxyl or amine functional polyether plasticizers, are added to silyl terminated polymer. One disadvantage with using these types of functional polyether plasticizers is storage stability of the resulting composition is adversely impacted when it is not stored in a moisture tight container. Another disadvantage with using these types of functional polyether plasticizers is heightened viscosities of compositions derived therefrom, which results in more material and labor waste from plugging and cleaning of application equipment.

### SUMMARY

There exists a need for a coating composition that provides acceptable permeability performance while having a particular viscosity range in order to be useful in spray applications. There is also a need for articles, films and a method of using these coating compositions.

In one aspect, the present disclosure provides a one-part, moisture curable coating composition including a silyl terminated polymer, wherein the silyl terminated polymer is a polyoxyalkylene polymer having at least one end group derived from an alkoxy silane, and a polyether plasticizer, and further the polyether plasticizer has a number average molecular weight between 300 g/mol to 600 g/mol.

In some embodiments, the coating composition has a moisture vapor transmission rate of 0.50 perm-cm or more according to ASTM E96 method. In some embodiments, the coating composition has a moisture vapor transmission rate of 0.65 perm-cm or more according to ASTM E96 method. In some embodiments, the polyether plasticizer is essentially free of primary or secondary hydroxyl and primary or secondary amine

In some embodiments, the coating composition is a liquid at ambient conditions. In some embodiments, the polyether plasticizer comprises from 5 to 50 parts by weight based on 100 parts by weight of the silyl terminated polymer. In some embodiments, the coating composition comprises at least 20 wt % of components (a) and (b) based on the total weight of the coating composition. In some embodiments, the coating composition further comprises fillers. In some embodiments, the coating composition further comprises solvent or solvents.

In another aspect, the present disclosure provides an article comprising a substrate coated with a coating comprising the coating composition of any of the preceding embodiments. In some embodiments, the coating is continuous.

In another aspect, the present disclosure provides a film comprising the coating composition of any of the preceding embodiments. In some embodiments, the film has a permeability of 0.50 perms-cm or more according to ASTM E 96.

In yet another aspect, the present disclosure provides a method of coating a substrate surface comprising applying the coating composition according to any of the preceding embodiments to a substrate surface and allowing it to cure. In some embodiments, the coating composition is applied at an ambient temperature of −20° C. or higher.

In another aspect, the present disclosure provides a method for controlling water vapor transport across a surface of a structure comprising: coating at least a portion of the surface of the structure with a coating composition comprising: (i) a silyl terminated polymer, wherein the silyl terminated polymer is a polyoxyalkylene polymer having at least one end group derived from an alkoxy silane, and (ii) a polyether plasticizer, and curing the coating composition.

Various aspects and advantages of exemplary embodiments of the present disclosure have been summarized. The above Summary is not intended to describe each illustrated embodiment or every implementation of the present disclosure. Further features and advantages are disclosed in the embodiments that follow. The Drawings and the Detailed Description that follow more particularly exemplify certain preferred embodiments using the principles disclosed herein.

### DETAILED DESCRIPTION

As used in this specification, the recitation of numerical ranges by endpoints includes all numbers subsumed within that range (e.g. 1 to 5 includes 1, 1.5, 2, 2.75, 3, 3.8, 4, and 5, and the like).

Unless otherwise indicated, all numbers expressing quantities or ingredients, measurement of properties and so forth used in the Specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following defined terms, these definitions shall be applied for the entire Specification, including the claims, unless a different definition is provided in the claims or elsewhere in the Specification based upon a specific reference to a modification of a term used in the following Glossary:

### Glossary

The words “a”, “an”, and “the” are used interchangeably with “at least one” to mean one or more of the elements being described.

The term “layer” refers to any material or combination of materials on or overlaying a substrate.

Words of orientation such as “atop, “on,” “covering,” “uppermost,” “overlaying,” “underlying” and the like for describing the location of various layers, refer to the relative position of a layer with respect to a horizontally-disposed, upwardly-facing substrate. It is not intended that the substrate, layers or articles encompassing the substrate and layers, should have any particular orientation in space during or after manufacture.

The term “separated by” to describe the position of a layer with respect to another layer and the substrate, or two other layers, means that the described layer is between, but not necessarily contiguous with, the other layer(s) and/or substrate.

The term “(co)polymer” or “(co)polymeric” includes homopolymers and copolymers, as well as homopolymers or copolymers that may be formed in a miscible blend, e.g., by coextrusion or by reaction, including, e.g., transesterification. The term “copolymer” includes random, block, graft, and star copolymers.

The term “permeable” as used herein means a film having a permeability of more than 10 perms according to ASTM E 96.

The term “continuous” as used herein means a coating having an uninterrupted extension in along a two dimensional surface. For example, in some embodiments, an article having a continuous coating over a surface of a substrate may be a building envelope where the coating covers the entire outer surface of the building with no interruptions.

The term “liquid” as used herein means substances that have a definite volume but no fixed shape at ambient conditions. Exemplary liquids useful in the present disclosure include solutions, mixtures, emulsions and suspensions where the primary component in such solutions, mixtures, emulsions and/or suspensions have a definite volume but no fixed shape at ambient conditions.

The present disclosure provides one component, moisture curable coating compositions comprising silyl terminated polymer and polyether plasticizer, which are useful in air barrier systems. The presently disclosed coating compositions can be applied by spray, liquid, roller, trowel, as an article and/or a film and are allowing water vapor transport and blocking air and liquid water across a surface of a structure. In some embodiments, the presently disclosed coating composition is liquid at ambient conditions.

In some embodiments, the presently disclosed coating composition a one-part, moisture curable coating composition comprising (a) a silyl terminated polymer, wherein the silyl terminated polymer is a polyoxyalkylene polymer having at least one end group derived from an alkoxy silane, and (b) a polyether plasticizer.

The presently disclosed coating compositions also include a polyether plasticizer. Polyether plasticizer is useful to increase moisture vapor transmittance rates for coating, articles and films made using the presently disclosed coating compositions. In some embodiments, the amount of polyether plasticizer used in the coating composition is varied to achieve desired permeability of the coating composition and articles and films made therefrom.

Other ingredients useful in the presently disclosed coating compositions include various additives such as dehydrating agents, rheology additives, compatibilizers, tackifiers, physical property modifiers, photocurable substances, oxygen-curable substances, storage stability improving agents, fillers, epoxy resins, epoxy resin curing agents antioxidants, adhesion promoters, ultraviolet absorbers, metal deactivators, antiozonants, antioxidants, light stabilizers, lubricants, amine type radical chain inhibitors, phosphorus-containing peroxide decomposers, lubricants, pigments, foaming agents, solvents, flame retardants, antifungal agents, blowing agents, and antistatic agents, each in an adequate amount. These additives may be added singly to the curable composition or two or more thereof may be added in combination to the curable composition. Specific examples of these additives are disclosed in publications such as Japanese Kokoku Publications H4-69659 and H7-108928, and Japanese Kokai Publications S63-254149, S64-22904, 2001-72854, and 2008-303650.

In the coating compositions of the present invention, there may further be added U.V. stabilizers or antioxidants in an amount of from 0-5 parts per 100 parts silyl terminated polymer. These materials improve heat stability and UV resistance, although the later effect is less important when the sealer composition of the invention is painted over. Useful sources of U.V. stabilizers and antioxidants include those available under the trade designations “TINUVIN 770”, “TINUVIN 327”, “TINUVIN 1130” and “TINUVIN 292” from Ciba-Geigy.

The silyl terminated polymers useful in the present disclosure are commercially available from Kaneka Corporation under the trade designations “KANEKA MS POLYMER” and “KANEKA SILYL”, and from Union Carbide Specialty Chemicals Division under the trade designations “SILMOD-SAT10”, “SILMOD SAT30”, “SILMOD SAT 200”, “SILMOD S203”, “SILMOD S303”, “SILMOD 20A”, to name several, which were obtained from Union Carbide Company. It is explained that trade named “SILMOD” resins are the same basic chemistries as some trade named “MS” resins available from Kanegafuchi Kagaku Kogyo Kabushiki Kaisha, Osaka Japan, e.g., the sealer available under trade designation “SILMOD S203” corresponds to the sealer available under trade designation “MS S203”, the sealer available under trade designation “SILMOD S303” corresponds to the sealer available under trade designation “MS S303”, and the sealer available under trade designation “SILMOD 20A” corresponds to the sealer available under trade designation “MS 20A”. Further, the trade designated “SILMOD” resins are the same basic chemistries as some trade designated “SILYL” resins also available from Kanegafuchi Kagaku Kogyo Kabushiki Kaisha, Osaka Japan, e.g., the sealer available under the trade designation “SILMOD SAT10” corresponds to the sealer available under the trade designation “SILYL SAT10”, the sealer available under the trade designation “SILMOD SAT30” corresponds to the sealer available under the trade designation “SILYL SAT30”, and the sealer available under the trade designation “SILMOD 200” corresponds to the sealer available under the trade designation “SILYL 200”.

A production method of a polyoxyalkylene polymer having a reactive silicon group may include those proposed in Japanese Kokoku Publication S45-36319, Japanese Kokoku Publication S46-12154, Japanese Kokai Publication S50-156599, Japanese Kokai Publication S54-6096, Japanese Kokai Publication S55-13767, Japanese Kokai Publication S55-13468, Japanese Kokai Publication S57-164123, Japanese Kokoku Publication H3-2450, U.S. Pat. No. 3,632,557, U.S. Pat. No. 4,345,053, U.S. Pat. No. 4,366,307, and U.S. Pat. No. 4,960,844, etc. Also, polyoxyalkylene polymers having a number average molecular weight of 6,000 or higher and a Mw/Mn ratio of 1.6 or lower and thus having high molecular weight and narrow molecular weight distribution as disclosed in Japanese Kokai Publication S61-197631, Japanese Kokai Publication S61-215622, Japanese Kokai Publication S61-215623, Japanese Kokai Publication S61-218632, Japanese Kokai Publication H3-72527, Japanese Kokai Publication H3-47825, and Japanese Kokai Publication H8-231707 can be exemplified, and is not limited to these examples.

In some embodiments, the main chain of the polyoxyalkylene polymer may contain another component such as a urethane bond component in an extent that the effects of the present disclosure is not so significantly adversely affected. The aforementioned urethane bond component is not particularly limited and may include a group (hereinafter, also referred to as an amido segment) produced by reaction of an isocyanato group and an active hydrogen group.

The amido segment is a group represented by the following formula (I):

—NR⁵—C(=0)-

(wherein R⁵ represents a hydrogen atom or a monovalent organic group, desirably a substituted or unsubstituted monovalent C₁₋₂₀ hydrocarbon group, and more desirably a substituted or unsubstituted monovalent C₁₋₈ hydrocarbon group).

The aforementioned amido segment may specifically include a urethane group produced by reaction of an isocyanato group and a hydroxy group; a urea group produced by reaction of an isocyanato group and an amino group; and a thiourethane group produced by reaction of an isocyanato group and a mercapto group. Also, in the present disclosure, groups produced by reaction of an active hydrogen in the aforementioned urethane group, urea group, and thiourethane group further with an isocyanato group are also included as the group represented by the formula I.

Examples of methods for industrially easily producing a polyoxyalkylene polymer having an amide segment and a reactive silicon group include those disclosed in Japanese Kokoku Publication S46-12154 (U.S. Pat. No. 3,632,557), Japanese Kokai Publications S58-109529 (U.S. Pat. No. 4,374,237), S62-13430 (U.S. Pat. No. 4,645,816), H8-53528 (EP 0676403), and H10-204144 (EP 0831108), Japanese Kohyo Publication 2003-508561 (U.S. Pat. No. 6,197,912), Japanese Kokai Publications H6-211879 (U.S. Pat. No. 5,364,955), H10-53637 (U.S. Pat. No. 5,756,751), H11-100427, 2000-169544, 2000-169545 and 2002-212415, Japanese Patent No. 3,313,360, U.S. Pat. Nos. 4,067,844 and 3,711,445, Japanese Kokai Publications 2001-323040, H11-279249 (U.S. Pat. No. 5,990,257), 2000-119365 (U.S. Pat. No. 6,046,270), S58-29818 (U.S. Pat. No. 4,345,053), H3-47825 (U.S. Pat. No. 5,068,304), H11-60724, 2002-155145, and 2002-249538, WO03/018658, WO03/059981, and Japanese Kokai Publication H6-211879 (U.S. Pat. No. 5,364,955), H10-53637 (U.S. Pat. No. 5,756,751), H10-204144 (EP0831108), 2000-169544, 2000-169545, 2000-119365 (U.S. Pat. No. 6,046,270).

The (meth)acrylic ester polymer having a reactive silicon group may be added to the curable composition of the present invention if necessary. A (meth)acrylic ester monomer composing the main chain of the above-mentioned (meth)acrylic ester polymer is not particularly limited and various monomers may be used. Examples thereof include (meth)acrylic acid monomers such as (meth)acrylic acid, methyl(meth)acrylate, ethyl(meth)acrylate, n-propyl(meth)acrylate, isopropyl(meth)acrylate, n-butyl(meth)acrylate, isobutyl(meth)acrylate, t-butyl(meth)acrylate, n-pentyl(meth)acrylate, n-hexyl(meth)acrylate, cyclohexyl(meth)acrylate, n-heptyl(meth)acrylate, n-octyl(meth)acrylate, 2-ethylhexyl(meth)acrylate, nonyl(meth)acrylate, decyl(meth)acrylate, dodecyl(meth)acrylate, phenyl(meth)acrylate, tolyl(meth)acrylate, benzyl(meth)acrylate, 2-methoxyethyl(meth)acrylate, 3-methoxylbutyl(meth)acrylate, 2-hydroxyethyl(meth)acrylate, 2-hydroxypropyl(meth)acrylate, stearyl(meth)acrylate, glycidyl(meth)acrylate, 2-aminoethyl(meth)acrylate, [γ]-(methacryloyloxypropyl)trimethoxysilane, [γ]-(methacryloyloxypropyl)dimethoxymethylsilane, methacryloyloxymethyltrimethoxysilane, methacryloyloxymethyltriethoxysilane, methacryloyloxymethyldimethoxymethylsilane, methacryloyloxymethyldiethoxymethylsilane, ethylene oxide adduct of (meth)acrylic acid, trifluoromethylmethyl(meth)acrylate, 2-trifluoromethylethyl(meth)acrylate, 2-perfluoroethylethyl(meth)acrylate, 2-perfluoroethyl-2-perfluorohutylethyl(meth)acrylate, perfluoroethyl(meth)acrylate, trifluorotnethyl(meth)acrylate, bis(trifluoromethyl)methyl(meth)acrylate, 2-trifluoromethyl-2-perfluoroethylethyl(meth)acrylate, 2-perfluorohexylethyl(meth)acrylate, 2-perfluorodecylethyl(meth)acrylate, and 2-perfluorohexadecylethyl(meth)acrylate.

With respect to the (meth)acrylic ester polymer, the following vinyl monomers can be copolymerized together with a (meth)acrylic ester monomer. Examples of the vinyl monomer are styrene monomers such as styrene, vinyltoluene, methylstyrene, chlorostyrene, styrenesulfonic acid and its salts; fluorine-containing vinyl monomers such as perfluoroethylene, perfluoropropylene, and vinylidene fluoride; silicon-containing vinyl monomers such as vinyltrimethoxysilane and vinyltriethoxysilane; maleic anhydride, maleic acid, and monoalkyl and dialkyl esters of maleic acid; fumaric acid, and monoalkyl and dialkyl esters of finnaric acid; maleimide monomers such as maleimide, methylmaleimide, ethylmaleimide, propylmaleimide, butylmaleimide, hexylmaleimide, octylmaleimide, dodecylmaleimide, stearylmaleitnide, phenylmaleimide, and cyclohexylmaleimide; nitrile group-containing vinyl monomers such as acrylonitrile and methacrylonitrile; amido group-containing vinyl monomers such as acrylamide and methacrylamide; vinyl esters such as vinyl acetate, vinyl propionate,vinyl pivalate, vinyl benzoate, and vinyl cinnamate; alkenes such as ethylene and propylene; conjugated dienes such as butadiene and isoprene; and vinyl chloride, vinylidene chloride, allyl chloride, and allyl alcohol. They may be used alone or a plurality of them may be copolymerized. Of them, in terms of properties such as the physical properties of a produced material, polymers comprising a styrene monomer and a (meth)acrylic acid monomer are desirable. (Meth)acrylic ester polymers comprising acrylic ester monomers and a methacrylic ester monomer are more desirable and acrylic ester polymers comprising acrylic ester monomers are further desirable. In the present disclosure, these desirable monomers may be copolymerized with other monomers and also block-copolymerized with them. In that case, these desirable monomers are desirably contained at a ratio of 40% by weight or higher, in the above descriptions, (meth)acrylic acid means acrylic acid and/or methacrylic acid.

A synthesis method of the (meth)acrylic ester polymer is not particularly limited and a conventionally known method may be employed. A polymer obtained by a common free radical polymerization method using an azo compound, a peroxide or the like as a polymerization initiator has a problem that the molecular weight distribution value is generally as high as 2 or higher and the viscosity is thus high. Accordingly, a living radical polymerization method is desirably employed in order to obtain a (meth)acrylic ester polymer having narrow molecular weight distribution and low viscosity and having a crosslinkable functional group at a molecular chain end at a high ratio. Of the “living radical polymerization methods”, an “atom transfer radical polymerization method” for polymerizing a (meth) acrylic ester monomer using an organic halide, a halogenated sulfonyl compound or the like as an initiator and a transition metal complex as a catalyst has, in addition to the characteristics of the above-mentioned “living radical polymerization methods”, a wide range of the options of the initiator and the catalyst because a halogen, etc, which is relatively advantageous for the functional group conversion reaction is located at a molecular chain end. The atom transfer radical polymerization method is therefore further desirable as a production method of the (meth)acrylic ester polymer having a specified functional group. Examples of the atom transfer radical polymerization method are, for example, the method disclosed in Krzysztof Matyjaszewski et al., J. Am. Chem. Soc, vol. 117, p. 5614 (1995).

Examples of a production method of the (meth)acrylic ester polymer having a reactive silicon group are production methods employing free radical polymerization methods using chain transfer agents and disclosed in Japanese Kokoku Publication H3-14068, Japanese Kokoku Publication H4-55444, and Japanese Kokai Publication H6-211922. Also, a production method employing an atom transfer radical polymerization method is disclosed in Japanese Kokai Publication H9-272714 and the like; and the method is not limited to these exemplified methods. The above-mentioned (meth)acrylic ester polymers having a reactive silicon group may he used alone or two or more kinds of them may be used in combination. A method for producing an organic polymer involving blending a polyoxyalkylene polymer having a reactive silicon group with a (meth) acrylic ester polymer having a reactive silicon group is not particularly limited, and examples thereof include those disclosed in Japanese Kokai Publication S59-122541, S63-11264, H6-172631, and H11-116763. Further, a production method of the polyoxyalkylene polymer obtained by blending the (meth)acrylic ester polymer having a reactive silicon group may also include a method of polymerizing a (meth)acrylic ester monomer in the presence of a polyoxyalkylene polymer having a reactive silicon group. The methods are practically disclosed in Japanese Kokai Publication 559-78223, Japanese Kokai Publication S59-168014, Japanese Kokai Publication S60-228516, and Japanese Kokai Publication 560-228517, and are not particularly limited to them.

In some embodiments, the presently disclosed coating compositions include at least 0.1 wt. %, and preferably at least 0.5 wt. % of one or more water scavengers, and at most 5 wt. % and preferably not more than 2 wt. % of one or more water scavengers. Examples of water scavengers are silanes such as vinyltrimethoxysilane, vinyltriethoxysilane, vinylmethyldimethoxysilane, O-methylcarbamatomethyl-methyldimethoxysilane, O-methylcarbamatomethyl-trimethoxysilane, O-ethylcarbamatomethyl-methyldiethoxysilane, O-ethyl-carbamatomethyl-triethoxysilane, 3-methacryloyloxypropyl-trimethoxysilane, methacryloyloxymethyl-trimethoxysilane, methacryloyloxymethylmethyldimethoxysilane, methacryloyloxymethyltriethoxysilane, methacryloxymethylmethyl-diethoxysilane, 3-acryloxyoylpropyl-trimethoxysilane, acryloyloxymethyltrimethoxysilane, acryloyloxymethylmethyldimethoxysilane, acrylmethyltriethoxysilane, acryloyloxymethylmethyldiethoxysilane, alkylalkoxysilanes in general, or else further organofunctional silanes and other aminosilanes which are described as catalysts.

In some embodiments, the presently disclosed coating compositions include at least 0.1 wt. %, preferably at least 0.5 wt. % of one re more adhesion promoters. In some embodiments, the presently disclosed coating compositions include at most 5 wt. %, preferably not more than 2 wt. % of one or more adhesion promoters. Useful sources of adhesion promoters include those available under the trade designations “A1120”, “A187”, and “A189” from OSI and “Z9020” from Dow Chemical Amino silanes can be used as adhesion promoters. Specific examples of the amino silane include adhesion promoters are γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2aminoethyl)aminopropylmethyldiethoxysilane, γ-(2-aminoethyl)aminopropyltriisopropoxysilane, γ-(6-aminohexyl)aminopropyltrimethoxysilane, 3-(N-ethylamino)-2-methylpropyltrimethoxysilane, 2-aminoethylaminomethyltrimethoxysilane, N-cyclohexylaminomethyltriethoxysilane, N-cyclohexylaminomethyldiethoxymethylsilane, γ-ureidopropyltriethoxysilane, γ-ureidopropyltriethoxysilane, N-phenyl-γ-aminopropyltrimethoxysilane, N-phenylaminomethyltrimethoxysilane, N-benzyl-γ-aminopropyltrimethoxysilane, N-vinylbenzyl-γ-aminopropyltriethoxysilane, [Nu],[Nu]′-bis[3-trimethoxysilyl]propyl]ethylenediamine, N-cyclohexylaminomethyltrimethoxysilane, N-cyclohexylaminomethyldimethoxymethylsilane, and N-phenylaminomethyltrimethoxysilane.

In some embodiments, the presently disclosed coating composition may comprise one or more catalysts. The catalyst is preferably present in the presently disclosed coating composition in an amount of from about 0.05 wt. % to about 5 wt. %, more preferably from about 0.1 wt. % to about 2 wt. %, most preferably from about 0.1 wt. % to about 1 wt. %. organometallic compounds which are used as silanol condensation catalyst are preferred. The silanol condensation catalyst may be used in an amount of from about 0.01 to about 20 parts by weight per 100 parts by weight of the silyl-terminated polymer, with a more preferred addition level being from about 0.1 to about 10 parts by weight per 100 parts by weight of the silyl-terminated polymer. Examples of silanol condensation catalysts include, but are not limited to, titanate esters such as tetrabutyl titanate and tetrapropyl titanate; organotin compounds such as dibutyltin dilaurate, dibuytltin maleate, dibutyltin diacetate, stannous octylate, stannous napthenate, reaction products from dibutyltin oxide and phthalate esters, and dibutyltin diacetylacetonate; organoaluminum compounds such as aluminum trisacetylacetonate, aluminum tris(ethylacetoacetate) and diisopropocyaluminum ethyl acetoacetate; reaction products from bismuth salts and organic carboxylic acids, such as bismuth tris(2-ethylhexonate) and bismuth tris(neodecanoate); chelate compounds such as zirconium tetra-acetylacetonate and titanium tetra-acetylactonate; organolead compounds such as lead octylate; organovanadium compounds; amine compounds such as butylamine, octylamine, dibutylamine, monoethanolamine, oleylamine, cyclohexylamine, benzylamine, diethylaminopropylamine, xylenediamine, triethylenediamine, guanidine,diphenylguanidine, 2,4,6-tris(dimethylaminomethyl)phenol, morpholine, N-methylmorpholine, 2-ethyl-4-methylimidazole with carboxylic or other acids; low-molecular-weight polyamide resins derived from excess polyamines and polybasics acids; and reaction products from excess polyamines and epoxy compounds. These may be used individually or in combination. The amine compounds are not limited to one mentioned above.

In some embodiments, the presently disclosed coating compositions may comprise one or more pigments or fillers. Useful fillers are typically solids that are non-reactive with the other components of the compositions of the invention. Useful fillers include, for example, clay, talc, dye particles, pigments and colorants (for example, TiO₂ or carbon black), glass beads, metal oxide particles, silica particles, ceramic microspheres, hollow polymeric microspheres (such as those available under the trade designation “EXPANCEL 551 DE” from Akzo Nobel, Duluth, Ga.), hollow glass microspheres (such as those available under the trade designation “K37” from Minnesota Mining and Manufacturing Co., St Paul, Minn.), carbonates, metal oxides, silicates (e.g. talc, asbestos, clays, mica), sulfates, silicon dioxide and aluminum trihydrate.

Some specific examples include ground or light calcium carbonate (with or without a surface-treatment such as a fatty acid, resin acid, cationic surfactant, or anionic surfactant); magnesium carbonate; talc; sulfates such as barium sulfate; alumina; metals in powder form (e.g., aluminum, zinc and iron); bentonite; kaolin clay; quartz powder; and combinations of two or more.

Examples of useful organic pigments include halogenated copper phthalocyanines, aniline blacks, anthraquinone blacks, benzimidazolones, azo condensations, arylamides, diarylides, disazo condensations, isoindolinones, isoindolines, quinophthalones, anthrapyrimidines, flavanthrones, pyrazolone oranges, perinone oranges, beta-naphthols, BON arylamides, quinacridones, perylenes, anthraquinones, dibromanthrones, pyranthrones, diketopyrrolo-pyrrole pigments (DPP), dioxazine violets, copper and copper-free phthalocyanines, indanthrones, and the like.

Examples of useful inorganic pigments include titanium dioxide, zinc oxide, zinc sulphide, lithopone, antimony oxide, barium sulfate, carbon black, graphite, black iron oxide, black micaceous iron oxide, brown iron oxides, metal complex browns, lead chromate, cadmium yellow, yellow oxides, bismuth vanadate, lead chromate, lead molybdate, cadmium red, red iron oxide, Prussian blue, ultramarine, cobalt blue, chrome green (Brunswick green), chromium oxide, hydrated chromium oxide, organic metal complexes, laked dye pigments and the like.

The filler can also comprise conductive particles (see, for example, U.S. Patent Application Pub. No. 2003/0051807, which is incorporated herein by reference) such as carbon particles or metal particles of silver, copper, nickel, gold, tin, zinc, platinum, palladium, iron, tungsten, molybdenum, solder or the like, or particles prepared by covering the surface of these particles with a conductive coating of a metal or the like. It is also possible to use non-conductive particles of a polymer such as polyethylene, polystyrene, phenol resin, epoxy resin, acryl resin or benzoguanamine resin, or glass beads, silica, graphite or a ceramic, whose surfaces have been covered with a conductive coating of a metal or the like.

Preferred fillers include inorganic solids such, for example, talc, titanium dioxide, silica, zirconia, calcium carbonate, calcium magnesium carbonate, glass or ceramic microspheres, and combinations thereof. In some embodiments, titanium dioxide and/or calcium carbonate are preferred.

In some embodiments, the coating composition comprises plasticizers. If appropriate, the coating composition can be produced with additional use of plasticizers in which case the plasticizers used do not contain any groups reactive toward silane/alkoxysilane. Plasticizers which can be utilized in the resinous compositions of the present disclosure include plasticizers such as esters of organic carboxylic acids or anhydrides thereof, such as phthalates, for example dioctyl phthalate, diisononyl phthalate or diisodecyl phthalate, adipates, for example dioctyl adipate, azelates and sebacates. Specific examples are the dialkyl phthalates such as di-(2-ethyl-hexyl)-pththalates, dibutyl phthalate, diethyl phthalate, dioctyl phthalate, butyl octyl phthalate; dicyclohexyl phthalate, butyl benzyl phthalate; triaryl phosphates such as tricresyl phosphate, triphenyl phosphate, cresyl(liphenyl phosphate; trialkyl phosphates such as trioctyl phosphate and tributyl phosphate; alkoxyalkyl phosphates such as trisbutoxyethyl phosphate: alkyl aryl phosphates such as octyldiphenyl phosphate; alkyl adipates such as di-(2-ethylhexyl)adipate, diisooctyl adipate, octyl decyladinate; dialkyl sebacates such as dibutyl sebacate, dioctylsebacate, diisooctyl sebacate; alkyl azelates such as di(2-ethylhexy)azelate and di-(2-ethylbutyl)azelate; citrates such as acetyl tri-n-butyl citrate, acetyl triethyl citrate, monoisopropyl citrate, triethyl citrate, mono-, di-, and tri-stearyl citrate; triacctin, p-tert-butyl and mixtures of thereof. For example, plasticizers useful in the present disclosure may include esters, such as triethylene glycol bis(2-ethylhexanoate) commercially available under the trade designation “Eastman TEG-EH” from Eastman.

The amount of plasticizer employed, if one is employed, will depend on the nature of the polymeric resin and the plasticizer,

In some embodiments, the presently disclosed coating compositions may comprise one or more light stabilizers and/or UV-absorbers. Light stabilizers useful in the present disclosure may include, for example, those available under the trade designation “TINUVIN(R) 292” from Ciba/BASF. UV-absorbers that may find utility in the presently disclosed coating composition may include, for example, those available under the trade designation “TINUVIN(R) 1130” from Ciba/BASF.

In some embodiments, the coating composition may comprise one or more solvents. Solvent should be non-reactive and examples of such includes aliphatic, aromatic or araliphatic solvent. Examples of suitable solvent include methoxypropyl acetate, methoxyethyl acetate, ethylene glycol diacetate, propylene glycol diacetate, glyme, diglyme, dioxane, tetrahydrofuran, dioxolane, tert-butyl methyl ether, ethyl acetate, butyl acetate, chloroform, methylene chloride, chlorobenzene, o-dichlorobenzene, anisole, 1,2-dimethoxybenzene, phenyl acetate, N-methyl-2-pyrrolidone, dimethylformamide, N,N-dimethylacetamide, dimethyl sulphoxide, acetonitrile, phenoxyethyl acetate and/or mixtures thereof, preferably solvent containing ether and ester groups, such as methoxypropyl acetate, acetone, 2-butanone, xylene, toluene, cyclohexanone, 4-methyl-2-pentanone, 1-methoxyprop-2-yl acetate, ethylene glycol monomethyl, 3-methoxy-n-butyl acetate, white spirit, more highly substituted aromatics such as are commercially available, for example, under the trade designations “NAPTHA”, “SOLVESSO”, “ISOPAR”, “NAPPAR” from Deutsche EXXON CHEMICAL GmbH, Cologne, Del.; “SHELLSOL” from Deutsche Shell Chemie GmbH, Eschborn, Del.; methyl n-amyl ketone (“MAK”) and “AROMATIC 100” “AROMATIC 150” from ExxonMobile Chemical; xylene, methyl isobutyl ketone (“MIBK”) and ethyl 3-ethoxypropionate from Eastman Chemical Company; and/or methyl ethyl ketone (“MEK”).

In the curable composition of the present disclosure, if necessary, there may be incorporated a thixotropic agent (anti-sagging agent) that prevents the curable composition from sagging and improves the workability thereof. The thixotropic agent is not particularly restricted but includes: polyamide waxes; hydrogenated castor oil derivatives; and metal soaps such as calcium stearate, aluminum stearate and barium stearate. Further, when those rubber powders having a particle size of 10 to 500 μm which are disclosed in Japanese Kokai Publication H11-349916, and those organic fibers disclosed in Japanese Kokai Publication 2003-155389 are used, it is possible to obtain a curable composition which has high thixotropy and favorable workability. These thixotropic agents (anti-sagging agents) may be used singly or two or more species may be used in combination. The addition level of the thixotropic agent is desirably 0.05 to 15 parts by weight per 100 parts by weight of silyl terminated polymer.

In some embodiments, the presently disclosed coating composition has a moisture vapor transmission rate of 0.50 perm-cm or more according to ASTM E96 method. In some embodiments, the presently disclosed coating composition has a moisture vapor transmission rate of 0.65 perm-cm or more according to ASTM E96 method.

In some embodiments, the presently disclosed coating composition is used to make an article having a substrate coated with a coating comprising the presently disclosed coating composition. In some embodiments, the coating is continuous. In some embodiments, thickness of the coating is varied to achieve desired permeability of the article. In some embodiments, the amount of polyether plasticizer used in the coating composition is varied to achieve desired permeability of the article. In some embodiments, the amount of polyether plasticizer used in the coating composition and the thickness of the coating are varied to achieve desired permeability of the article.

The present disclosure provides a film made using the presently disclosed coating composition. In some embodiments, the film has a permeability of greater than 10 perms according to ASTM E 96. In some embodiments, the presently disclosed films have at least 200% elongation and moisture vapor transmission rates of 11 perms to 30 perms according to ASTM E 96. In some embodiments, thickness of the coating is varied to achieve desired permeability of the film. In some embodiments, the amount of polyether plasticizer used in the coating composition, which is used in the film, is varied to achieve desired permeability of the film. In some embodiments, the amount of polyether plasticizer used in the coating composition and the thickness of the coating are varied to achieve desired permeability of the film.

The presently disclosed coating composition is useful in a method of coating a substrate surface including the steps of applying the presently disclosed coating composition to a substrate surface and allowing it to cure. In some embodiments, the coating composition is applied at an ambient temperature of −20° C. or higher.

The present disclosure also provides a method for allowing water vapor transport and blocking air and liquid water across a surface of a structure including the steps of: (a) coating at least a portion of the surface of the structure with any of the presently disclosed embodiments for a coating composition; and (b) curing the coating composition. In some embodiments, the coating composition, article and/or film is applied on an exterior sheathing layer, which is commonly plywood, oriented strand board (OSB), foam insulation sheathing, nonwoven glass mat faced gypsum sheathing board, or other conventional sheathing materials commonly used in the construction industry. Useful exterior cladding layer is made up of brick, concrete blocks, reinforced concrete, stone, vinyl siding, fiber cement board, clapboard, or other known exterior siding materials. In some embodiments, the coating composition, article and/or film is applied to a roofing deck, an attic floor or other attic surface, a boundary between a wall, roof system, and/or foundation, other interior or exterior surfaces of a structure, or used as flashing around a roof penetration.

Following are exemplary embodiments and combinations of embodiments according to the present disclosure:
1. A one-part, moisture curable coating composition comprising:

(a) a silyl terminated polymer, wherein the silyl terminated polymer is a polyoxyalkylene polymer having at least one end group derived from an alkoxy silane, and

(b) a polyether plasticizer,

and further the polyether plasticizer has a number average molecular weight between 300 g/mol to 600 g/mol.
2. The coating composition of embodiment 1 wherein the coating composition has a moisture vapor transmission rate of 0.50 perm-cm or more according to ASTM E96 method.
3. The coating composition of embodiment 1 wherein the coating composition has a moisture vapor transmission rate of 0.65 perm-cm or more according to ASTM E96 method.
4. The coating composition of any of the preceding embodiments wherein the polyether plasticizer is essentially free of primary or secondary hydroxyl and primary or secondary amine
5. The composition of any of the preceding embodiments wherein the coating composition is a liquid at ambient conditions.
6. The coating composition of any of the preceding embodiments, wherein the polyether plasticizer comprises from 5 to 50 parts by weight based on 100 parts by weight of the silyl terminated polymer.
7. The coating composition of any of the preceding embodiments wherein the coating composition comprises at least 20 wt % of components (a) and (b) based on the total weight of the coating composition.
8. The coating composition of any of the preceding embodiments further comprising fillers.
9. The coating composition of any of the preceding embodiments further comprising solvent or solvents.
10. An article comprising a substrate coated with a coating comprising the coating composition of any of the preceding embodiments.
11. The article of embodiment 10 wherein the coating is continuous.
12. A film comprising the coating composition of any of the preceding embodiments.
13. The film of embodiment 12 wherein the film has a permeability of 0.50 perms-cm or more according to ASTM E 96.
14. A method of coating a substrate surface comprising applying the coating composition according to any of embodiments 1 to 10 to a substrate surface and allowing it to cure.
15. The method of embodiment 14 wherein the coating composition is applied at an ambient temperature of −20° C. or higher.
16. A method for controlling water vapor transport across a surface of a structure comprising:

(a) coating at least a portion of the surface of the structure with a coating composition comprising:

(i) a silyl terminated polymer, wherein the silyl terminated polymer is a polyoxyalkylene polymer having at least one end group derived from an alkoxy silane, and

(ii) a polyether plasticizer, and

(b) curing the coating composition.

Exemplary embodiments of the present disclosure have been described above and are further illustrated below by way of the following Examples, which are not to be construed in any way as imposing limitations upon the scope of the present disclosure. On the contrary, it is to be clearly understood that resort may be had to various other embodiments, modifications, and equivalents thereof which, after reading the description herein, may suggest themselves to those skilled in the art without departing from the spirit of the present disclosure and/or the scope of the appended claims.

Following are various embodiments of the present disclosure:

### EXAMPLES

The following examples are intended to illustrate exemplary embodiments within the scope of this disclosure. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Raw Material and Suppliers List

| Raw Material | Supplier | Origin |
|---|---|---|
| MS POLYMER S303H | Kaneka Polymers | Pasadena, TX |
| AEROSIL R202 | Evonik Degussa | Parsippany, NJ |
| | Corporation | |
| ULTRA-PFLEX PCC | Specialty Minerals Inc. | Adams, MA |
| OMYACARB 5-FL | Omya Inc. | Florence, VT |
| TIONA 696 | Cristal Global | Jeddah, Saudi Arabia |
| DYNASYLANDAMO-T | Evonik Degussa | Parsippany, NJ |
| | Corporation | |
| DYNASYLAN VTMO | Evonik Degussa | Parsippany, NJ |
| | Corporation | |
| NEOSTANN U220H | Nitto Kasei Co., Ltd. | Japan |
| dibutyltin bis | | |
| (acetylacetonate) | | |
| XYLENE | Sigma-Aldrich | St. Louis, MO |
| HALLSTAR TP-90B | Hallstar | Bedford Park, IL |
| HALLSTAR TP-759 | Hallstar | Bedford Park, IL |

### Test Methods

Moisture vapor transmittance rate (MVTR) of the example samples described below were determined in accordance with the ASTM E 96 (2010) “Standard test method for water vapor transmission of materials”, obtained from IHS Inc., Englewood, Colo. The results are summarized in Table 1.

Tensile and elongation testing (conical mandrel testing) of the example samples described below were determined in accordance with the ASTM D412 (2008) “Standard test method for vulcanized rubber and thermoplastic elastomers-tension”, obtained from IHS Inc., Englewood, Colo. The results are summarized in Table 2.

### Example 1

The moisture cure coating composition consists of resin, plasticizer, rheology modifier, extenders, pigments, moisture scavenger, adhesion promoter, catalyst and solvents. The following ingredients were used, 46 g of MS S303H, 10 g of HALLSTAR TP 90B plasticizer, 0.6 g of AEROSIL R202, 27 g of OMYACARB 5-FL, 5 g of titanium oxide TIONA 696, 1 g of DYNASYLAN DAMO-T, 0.7 g of DYNASYLAN VTMO, 0.25 g of NEOSTANN U220H and 8.15 g of xylene. Formulations were blended using a dual asymmetric centrifuge mixer. Formulation components 46 g of MS S303H, 10 g of HALLSTAR TP 90B plasticizer, 0.6 g of AEROSIL R202, 27 g of calcium carbonate OMYACARB5-FL, 5 g of titanium oxide TIONA 696 were charged into a mixing vessel, placed in the mixer and mixed at 2500 rpm for 4 minutes. Following this, 1 g of DYNASYLAN DAMO-T and 0.7 g of DYNASYLAN VTMO were charged into mixing vessel and mixed for 2500 rpm for 1 m in. After this time, catalyst 0.25 g of NEOSTANN U220H was added and mixed for 2500 rpm for 30 sec. 8.15 g of a xylene solvent was added to same mixing vessel and mixed for 1500 rpm for 1 minute. Coatings were made on a substrate made of TEFLON material at 0.89 mm (35 mil) wet thickness. The coatings were allowed to cure at 20° C. for 7 days. Moisture vapor transmittance rate and tensile and elongation testing were done after this time.

### Example 2

The moisture cure coating composition consists of resin, plasticizer, rheology modifier, extenders, pigments, moisture scavenger, adhesion promoter, catalyst and solvents. The following ingredients were used, 46 g of MS S303H, 20 g of HALLSTAR TP 90B plasticizer, 0.6 g of AEROSIL R202, 27 g of OMYACARB 5-FL, 5 g of titanium oxide TIONA 696, 1 g of DYNASYLAN DAMO-T, 0.7 g of DYNASYLAN VTMO, 0.25 g of NEOSTANN U220H and 8.15 g of xylene. Formulations were blended using a dual asymmetric centrifuge mixer. Formulation components 46 g of MS S303H, 10 g of HALLSTAR TP 90B plasticizer, 0.6 g of AEROSIL R202, 27 g of calcium carbonate OMYACARB 5-FL, 5 g of titanium oxide TIONA 696 were charged into a mixing vessel, placed in the mixer and mixed at 2500 rpm for 4 minutes and then 10 g of HALLSTAR TP 90B plasticizer was added and mixed for 2500 rpm for 1 minutes. Following this, 1 g of DYNASYLAN DAMO-T, 0.7 g of DYNASYLAN VTMO were charged into mixing vessel and mixed for 2500 rpm for 1 min. After this time, catalyst 0.25 g of NEOSTANN U220H was added and mixed for 2500 rpm for 30 sec. 8.15 g of xylene solvent was added to same mixing vessel and mixed for 1500 rpm for 1 minute. Coatings were made on a substrate material made using TEFLON at 0.89 mm (35 mil) wet thickness. The coatings were allowed to cure at 20° C. for 7 days. Moisture vapor transmittance rate and tensile and elongation testing were done after this time.

### Example 3

The moisture cure coating composition consists of resin, plasticizer, rheology modifier, extenders, pigments, moisture scavenger, adhesion promoter, catalyst and solvents. The following ingredients were used, 46 g of MS S303H, 30 g of HALLSTAR TP 90B plasticizer, 0.6 g of AEROSIL R202, 27 g of OMYACARB 5-FL, 5 g of titanium oxide TIONA 696, 1 g of DYNASYLAN DAMO-T, 0.7 g of

DYNASYLAN VTMO, 0.25 g of NEOSTANN U220H and 8.15 g of xylene. Formulations were blended using a dual asymmetric centrifuge mixer. Formulation components 46 g of MS S303H, 10 g of MESOMOLL plasticizer, 0.6 g of AEROSIL R202, 27 g of calcium carbonate OMYACARB 5-FL, 5 g of titanium oxide TIONA 696 were charged into a mixing vessel, placed in the mixer and mixed at 2500 rpm for 4 minutes and then 20 g HALLSTAR TP 90B plasticizer was added and mixed for 2500 rpm for 1 minutes. Following this, 1 g DYNASYLAN DAMO-T, 0.7 g of DYNASYLAN VTMO were charged into mixing vessel and mixed for 2500 rpm for 1 min After this time, catalyst 0.25 g of NEOSTANN U220H was added and mixed for 2500 rpm for 30 sec. 8.15 g of the xylene solvent was added to same mixing vessel and mixed for 1500 rpm for 1 minute. Coatings were made on a substrate material made using TEFLON at 0.89 mm (35 mil) wet thickness. The coatings were allowed to cure at 20° C. for 7 days. Moisture vapor transmittance rate and tensile and elongation testing were done after this time.

### Example 4

The moisture cure coating composition consists of resin, plasticizer, rheology modifier, extenders, pigments, moisture scavenger, adhesion promoter, catalyst and solvents. The following ingredients were used, 46 g of MS S303H, 11 g of HALLSTAR TP 759 plasticizer, 0.6 g of AEROSIL R202, 27 g of OMYACARB 5-FL, 5 g of titanium oxide TIONA 696, 1 g of DYNASYLAN DAMO-T, 0.7 g of DYNASYLAN VTMO, 0.25 g of NEOSTANN U220H and 8.15 g of xylene. Formulations were blended using a dual asymmetric centrifuge mixer. Formulation components MS 46 g of S303H, 11 g of HALLSTAR TP 759 plasticizer, 0.6 g of AEROSIL S202, calcium carbonate 27 g of OMYACARB 5-FL, 5 g of titanium oxide TIONA 696 were charged into a mixing vessel, placed in the mixer and mixed at 2500 rpm for 4 minutes. Following this, 1 g of DYNASYLAN DAMO-T, 0.7 g of DYNASYLAN VTMO were charged into mixing vessel and mixed for 2500 rpm for 1 min. After this time, catalyst 0.25 g of NEOSTANN U220H was added and mixed for 2500 rpm for 30 sec. 8.15 g of the xylene solvent was added to same mixing vessel and mixed for 1500 rpm for 1 minute. Coatings were made on a substrate made using TEFLON material at 0.89 mm (35 mil) wet thickness. The coatings were allowed to cure at 20° C. for 7 days. Moisture vapor transmittance rate and tensile and elongation testing were done after this time.

### Example 5

The moisture cure coating composition consists of resin, plasticizer, rheology modifier, extenders, pigments, moisture scavenger, adhesion promoter, catalyst and solvents. The following ingredients were used, 46 g of MS S303H, 20 g of HALLSTAR TP 759 plasticizer, 0.6 g of AEROSIL R202, 27 g of OMYACARB 5-FL, 5 g of titanium oxide TIONA 696, 1 g of DYNASYLAN DAMO-T, 0.7 g of DYNASYLAN VTMO, 0.25 g of NEOSTANN U220H and 8.15 g of xylene. Formulations were blended using a dual asymmetric centrifuge mixer. Formulation components 46 g of MS S303H, 10 g of HALLSTAR TP 759 plasticizer, 0.6 g of AEROSIL R202, 27 g of calcium carbonate OMYACARB 5-FL, 5 g titanium oxide TIONA 696 were charged into a mixing vessel, placed in the mixer and mixed at 2500 rpm for 4 minutes and then 10 g of HALLSTAR TP 759 plasticizer was added and mixed for 2500 rpm for 1 minutes. Following this, 1 g of DYNASYLAN DAMO-T, 0.7 g of DYNASYLAN VTMO were charged into mixing vessel and mixed for 2500 rpm for 1 min. After this time, catalyst 0.25 g of NEOSTANN U220H was added and mixed for 2500 rpm for 30 sec. 8.15 g of the xylene solvent was added to same mixing vessel and mixed for 1500 rpm for 1 minute. Coatings were made on a substrate made using TEFLON at 0.89 mm (35 mil) wet thickness. The coatings were allowed to cure at 20° C. for 7 days. Moisture vapor transmittance rate and tensile and elongation testing were done after this time.

### Example 6

The moisture cure coating composition consists of resin, plasticizer, rheology modifier, extenders, pigments, moisture scavenger, adhesion promoter, catalyst and solvents. The following ingredients were used, 46 g of MS S303H, 30 g of HALLSTAR TP 759 plasticizer, 0.6 g of AEROSIL S202, 27 g of OMYACARB 5-FL, 5 g of titanium oxide TIONA 696, 1 g of DYNASYLAN DAMO-T, 0.7 g of DYNASYLAN VTMO, 0.25 g of NEOSTANN U220H and 8.15 g of xylene. Formulations were blended using a dual asymmetric centrifuge mixer. Formulation components 46 g of MS S303H, 10 g of HALLSTAR TP 759 plasticizer, 0.6 g of AEROSIL R202, 27 g of calcium carbonate OMYACARB 5-FL, 5 g titanium oxide TIONA 696 were charged into a mixing vessel, placed in the mixer and mixed at 2500 rpm for 4 minutes and then 20 g of HALLSTAR TP 759 plasticizer was added and mixed for 2500 rpm for 1 minutes. Following this, 1 g of DYNASYLAN DAMO-T, 0.7 g of DYNASYLAN VTMO were charged into mixing vessel and mixed for 2500 rpm for 1 min. After this time, catalyst 0.25 g of NEOSTANN U220H was added and mixed for 2500 rpm for 30 sec. 8.15 g of the xylene solvent was added to same mixing vessel and mixed for 1500 rpm for 1 minute. Coatings were made on a substrate made using TEFLON at 0.89 mm (35 mil) wet thickness. The coatings were allowed to cure at 20° C. for 7 days. Moisture vapor transmittance rate and tensile and elongation testing were done after this time.

TABLE 1
MVTR results

| | Specimen | | |
|---|---|---|---|
| Sample | Thickness | Permeance | Permeability |
| Description | (cm) | (perms) | (perm-cm) |
| Example 1 | 0.060 | 14.07 | 0.840 |
| Example 2 | 0.068 | 18.17 | 1.233 |
| Example 3 | 0.058 | 22.97 | 1.330 |
| Example 4 | 0.080 | 14.81 | 1.18 |
| Example 5 | 0.066 | 19.16 | 1.26 |
| Example 6 | 0.065 | 19.72 | 1.28 |

TABLE 2
Tensile and Elongation results

| | | | | | Energy | | | | |
|---|---|---|---|---|---|---|---|---|---|
| | | Peak | Strain At | | To | Load At | Strain | Break | Elongation |
| | Thickness | Stress | Break | Modulus | Break | Yield | At Yield | Stress | At Break |
| | cm | Mpa | % | Mpa | N * m | N | % | Mpa | cm |
| Example 1 | 0.061 | 1.40 | 292.56 | 0.85 | 0.23 | 5.38 | 292.56 | 1.40 | 7.44 |
| Example 2 | 0.064 | 1.13 | 330.02 | 0.54 | 0.21 | 4.58 | 336.40 | 1.13 | 8.38 |
| Example 3 | 0.056 | 0.94 | 359.45 | 0.36 | 0.16 | 3.25 | 349.58 | 0.94 | 9.12 |
| Example 4 | 0.061 | 1.18 | 301.81 | 0.69 | 0.19 | 4.54 | 299.72 | 1.18 | 7.67 |
| Example 5 | 0.061 | 1.15 | 306.08 | 0.66 | 0.19 | 4.36 | 297.54 | 1.15 | 7.77 |
| Example 6 | 0.062 | 1.14 | 308.52 | 0.65 | 0.19 | 4.36 | 299.56 | 1.14 | 7.85 |

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, all published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following listing of disclosed embodiments.

1. A one-part, moisture curable coating composition comprising:
(a) a silyl terminated polymer, wherein the silyl terminated polymer is a polyoxyalkylene polymer having at least one end group derived from an alkoxy silane, and
(b) a polyether plasticizer,
and wherein the polyether plasticizer has a number average molecular weight between 300 g/mol to 600 g/mol, and further wherein the polyether plasticizer is essentially free of primary or secondary hydroxyl and primary or secondary amine.

2. The coating composition of claim 1 wherein the coating composition has a moisture vapor transmission rate of 0.50 perm-cm or more according to ASTM E96 method.

3. The coating composition of claim 1 wherein the coating composition has a moisture vapor transmission rate of 0.65 perm-cm or more according to ASTM E96 method.

4. (canceled)

5. The composition of claim 1 wherein the coating composition is a liquid at ambient conditions.

6. The coating composition of claim 1, wherein the polyether plasticizer comprises from 5 to 50 parts by weight based on 100 parts by weight of the silyl terminated polymer.

7. The coating composition of claim 1 wherein the coating composition comprises at least 20 wt % of components (a) and (b) based on the total weight of the coating composition.

8. The coating composition of claim 1 further comprising fillers.

9. The coating composition of claim 1 further comprising solvent or solvents.

10. An article comprising a substrate coated with a coating comprising the coating composition of claim 1.

11. The article of claim 10 wherein the coating is continuous.

12. A film comprising the coating composition of claim 1.

13. The film of claim 12 wherein the film has a permeability of 0.50 perms-cm or more according to ASTM E 96.

14. A method of coating a substrate surface comprising applying the coating composition according to claim 1 to a substrate surface and allowing it to cure.

15. The method of claim 14 wherein the coating composition is applied at an ambient temperature of −20° C. or higher.

16. A method for controlling water vapor transport across a surface of a structure comprising:
(a) coating at least a portion of the surface of the structure with a coating composition comprising:
(i) a silyl terminated polymer, wherein the silyl terminated polymer is a polyoxyalkylene polymer having at least one end group derived from an alkoxy silane, and
(ii) a polyether plasticizer, wherein the polyether plasticizer is essentially free of primary or secondary hydroxyl and primary or secondary amine, and
(b) curing the coating composition.
